(19) United States
(12) Patent Application Publication
(10) Pub. No.: US 2006/0294133 A1
(43) Pub. Date: Dec. 28, 2006

(54) Producing a graphical representation of a written description

(75) Inventors: Andrew MacGregor Ritchie, Surrey (GB); Jonathan Marsden Bradshaw, Surrey (GB); Mark Jonathan Bernstein, Surrey (GB)

Correspondence Address: HARNESS, DICKEY & PIERCE, P.L.C., P.O. BOX 828, BLOOMFIELD HILLS, MI, 48303, US

(73) Assignee: Ablaise Limited of London, London (GB)

(21) Appl. No.: 11/475,535

(22) Filed: Jun. 27, 2006

(30) Foreign Application Priority Data
Jun. 27, 2005 (GB) 0512965.5

(51) Int. Cl. G06F 7/00

(52) U.S. Cl. 707/102

(57) ABSTRACT

A method of producing a graphical representation of a written description of an apparatus, method, system or device is disclosed. The written description includes one or more independent sentence definitions and, for at least one of said independent sentence definitions, at least one further limiting dependent sentence definition. Each of the independent sentence definitions and the dependent sentence definitions is constructed from one or more clauses describing an identifiable technical feature of said apparatus, method, system or device. The method comprising the steps of, at a data processing system: receiving first input data identifying a project set of sentence definitions; receiving second input data identifying independent sentence definitions; receiving third input data identifying dependent sentence definitions along with an indication of the sentence definition or definitions upon which said dependent sentence definitions are dependent; receiving fourth input data identifying clauses along with an indication of the sentence definitions of which they form a part thereof; building a graphical model of the relationship between said clauses showing how said clauses combine to form said sentence definitions; and producing output data showing an eye-readable graphical representation of said graphical model.

### CROSS REFERENCE TO RELATED APPLICATION

This application claims priority from United Kingdom Patent Application Number 0512965.5, filed 27 Jun. 2005, the entire disclosure of which is incorporated herein by reference in its entirety.

### TECHNICAL FIELD

The present invention relates to producing a graphical representation of a written description, preferably of an apparatus, method, system or device, wherein the description comprises one or more independent sentence definitions and, for at least one of said independent sentence definitions, at least one further limiting dependent sentence definition; wherein each of said independent sentence definitions and said dependent sentence definitions is constructed from one or more clauses defining an identifiable technical feature of said apparatus, method, system or device.

### BACKGROUND OF THE INVENTION

Procedures for the analysis of written descriptions, often in a legal context, are well known. Often this can involve creating notes, which may be considered as meta descriptions, which may include definitions and constructions of various phrases, along with notations as to how the various phrases interact; such that the overall scope of the written description may be considered.

In many situations, it is necessary to consider the written description with respect to a real physical apparatus, or, similarly, a method, system or device. In some situations it may be necessary to consider many such systems therefore the process of determining the relevance of the written description with respect to the physical entity may become a time consuming a laborious operation.

Under such circumstances, it may be preferable to deploy the exercise to a number of assistants but, such an approach becomes difficult because it is necessary to ensure that similar rules and constructions are being applied for each of the exercises involved. Thus, the overall exercise may become very time consuming and, as such, uneconomic to deploy in many situations where, were a more efficient technique available, a useful and constructive conclusion could be reached.

### BRIEF SUMMARY OF THE INVENTION

According to an aspect of the present invention, there is provided a method of producing a graphical representation of a written description as previously described, involving the method steps, at a data processing system, of receiving first input data identifying a project set of sentence definitions; receiving second input data identifying independent sentence definitions; receiving third input data identifying dependent sentence definitions along with an indication of the sentence definition or definitions upon which said dependent sentence definitions are dependent; receiving fourth input data identifying clauses along with an indication of the sentence definitions of which they form a part thereof; building a graphical model of the relationship between said clauses showing how said clauses combine to form a said sentence definitions; and producing output data showing an eye-readable graphical representation of said graphical model.

### BRIEF DESCRIPTION OF THE SEVERAL VIEWS OF THE DRAWINGS

FIG. 1 shows an example of a data processing system;

FIG. 2 details the data processing unit identified in FIG. 1;

FIG. 3 shows an example of a technical apparatus;

FIG. 4 shows an example of a written description for the technical apparatus shown in FIG. 3;

FIG. 5 illustrates procedures performed by the data processing system illustrated in FIG. 1;

FIG. 6 shows a data structure created in response to the operations performed as shown in FIG. 5;

FIG. 7 illustrates the creation of a graphical model; and

FIG. 8 illustrates the printing of the graphical model.

### DESCRIPTION OF THE BEST MODE FOR CARRYING OUT THE INVENTION

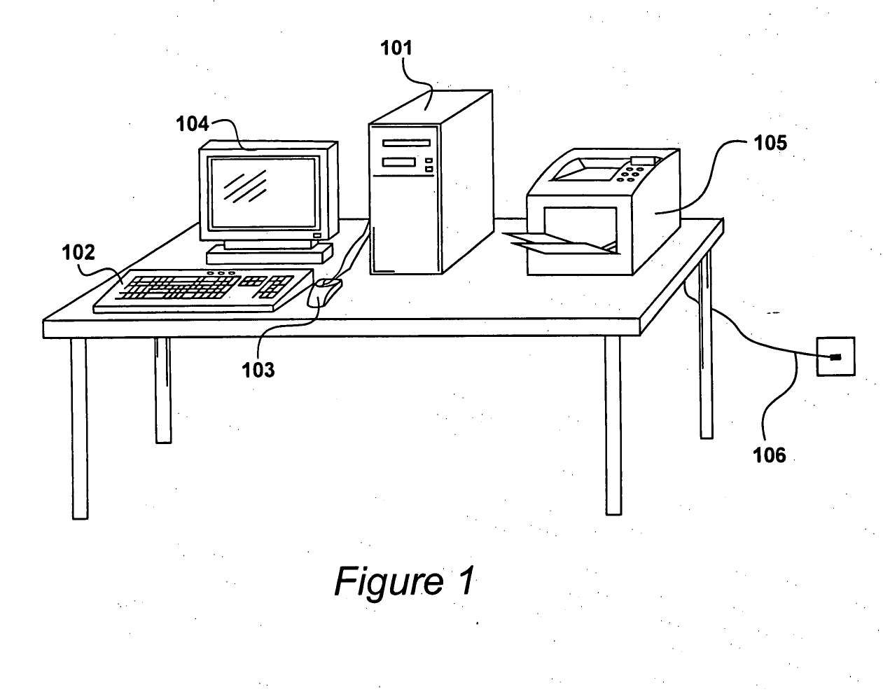

An example of a data processing system is illustrated in FIG. 1. A main data processing system unit 101 receives input data from manually operable devices, such a keyboard 102 and a mouse 103. Visual output data is displayed on a visual display unit 104 and a permanent print-out is produced by a printing device 105. A network connection is provided at 106.

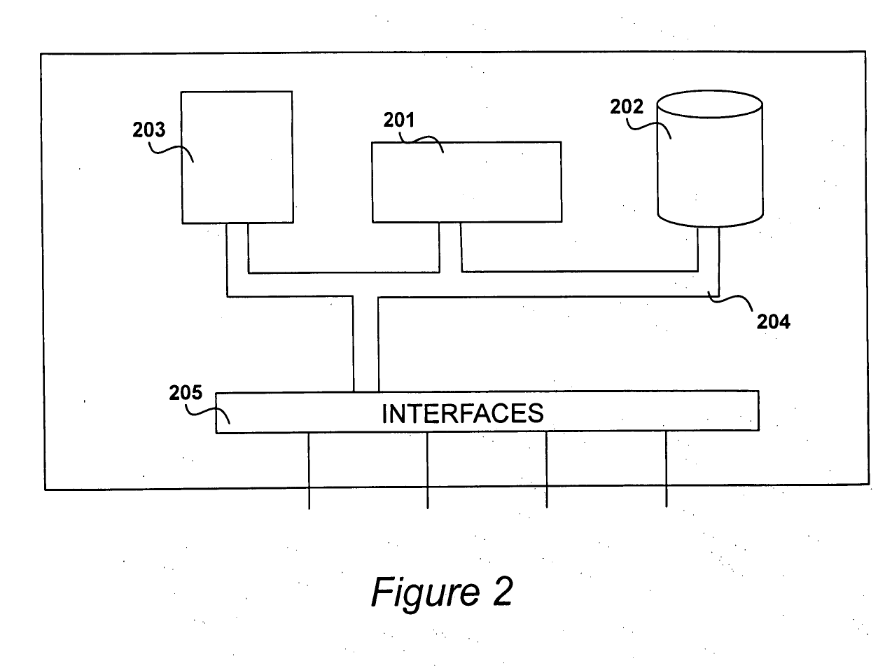

An example of data processing system unit 101 is detailed in FIG. 2. The unit includes a central processing unit 201, such as an Intel Pentium device or similar device produced by AMD or alternative manufacturers. Central processing device 201 communicates with a hard disk drive 202 and volatile random access memory devices 203 via a system bus 204. Communications to external devices, such as input devices 102, 103 and output devices 104 and 105 is performed via interface circuits 205.

Data processing system 101 receives executable instructions via data carrying media such as DVD-ROM devices or, alternatively, instructions may be received from a network connection 106.

Executable instructions are held by disk drive 202 and, upon initiation of system operation, instructions are loaded from disk drive 202 to volatile memory devices 203 for subsequent execution by programmable processing unit 201.

After program instructions have been installed, the system as a whole, which will be referred to herein as a data processing system, is configured to receive first input data identifying a project set of sentence definitions. Thereafter, second input data is received identifying independent sentence definitions forming part of the project set. Third input data is received identifying dependent sentence definitions along with an indication of the sentence definition or definitions upon which the dependent sentence definitions are dependent. Furthermore, fourth input data is received identifying clauses along with an induction of the sentence definitions of which they form a part thereof.

Having received the first, second, third and fourth input data sets, the data processing system is configured to build a graphical model of the relationship between the clauses showing how said clauses combine to form the sentence definitions. Furthermore, the data processing system is configured to produce output data, for display on visual display unit 104 or, in permanent form on image carrying media via printing device 105. Thus, the system is configured to produce output data showing an eye-readable graphical representation of the graphical model.

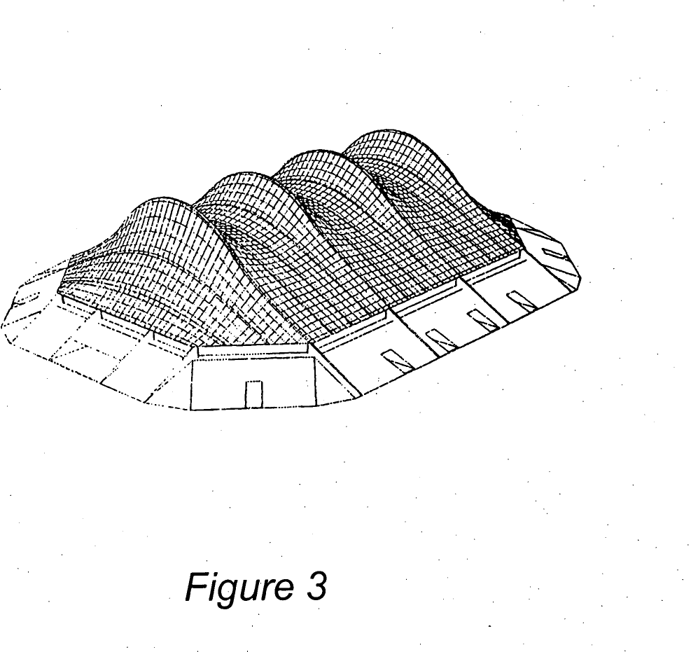

In this embodiment the method for producing output data showing a graphical representation is preferably deployed with respect to written descriptions of technical apparatus, methods, systems or devices. For the purposes of illustration only, reference will be made to the a particular apparatus having physical form which, in this example only, is a building structure having parabolic arches, as illustrated in FIG. 3. Referring to the building structure shown in FIG. 3, a tensile membrane is placed over the arches such that the membrane is in contact with the arches over a central region but extends away from the arches over a peripheral region. The membrane is secured in tension at its edges so as to define an anticlastic surface. A wall is built to present an upper wall surface above ground level and edges of the membrane are secured to the upper wall surface. A central floor area under the central region of the structure is exacted below ground level. The structure provides a large covered space for use as an arena or similar application while construction costs are substantially reduced compared to known configurations for facilitating similar applications.

This building structure has been defined in a written description and it is the purpose of the present preferred embodiment to process the data representing this description so as to provide a graphical representation. In this way, a comparison of the particular written description against other building structures embodying similar features may be made. Furthermore, the graphical representation facilitates the deployment of analysis of this type being carried out in parallel by a number of para-legal operatives.

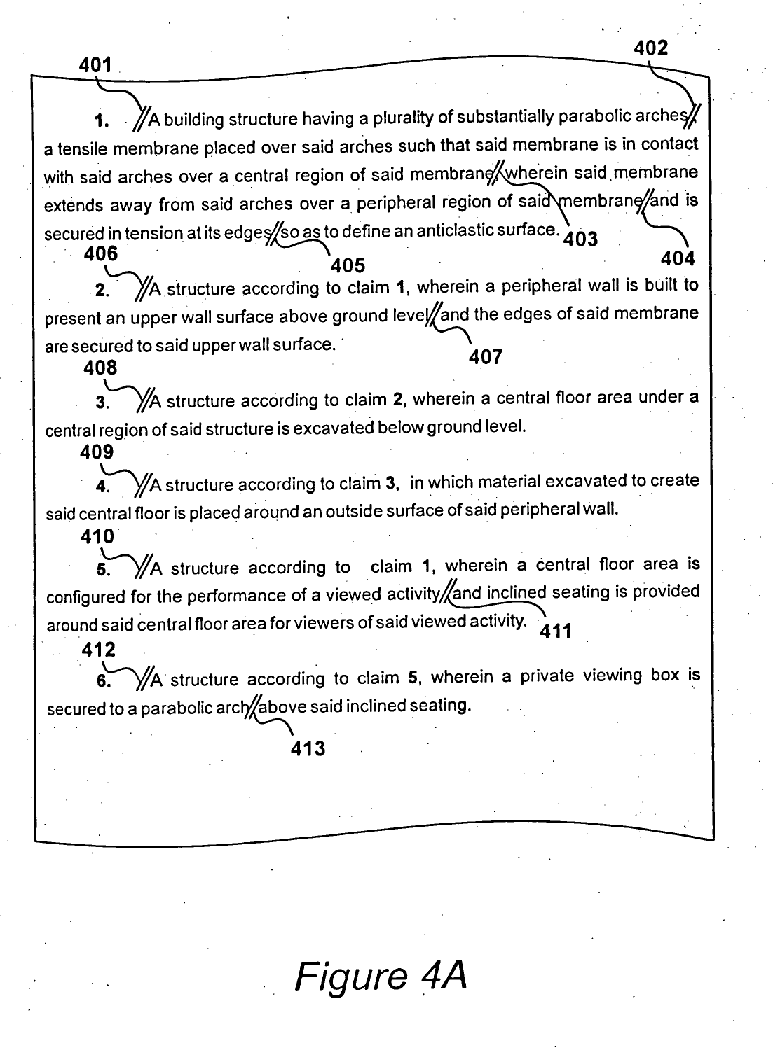

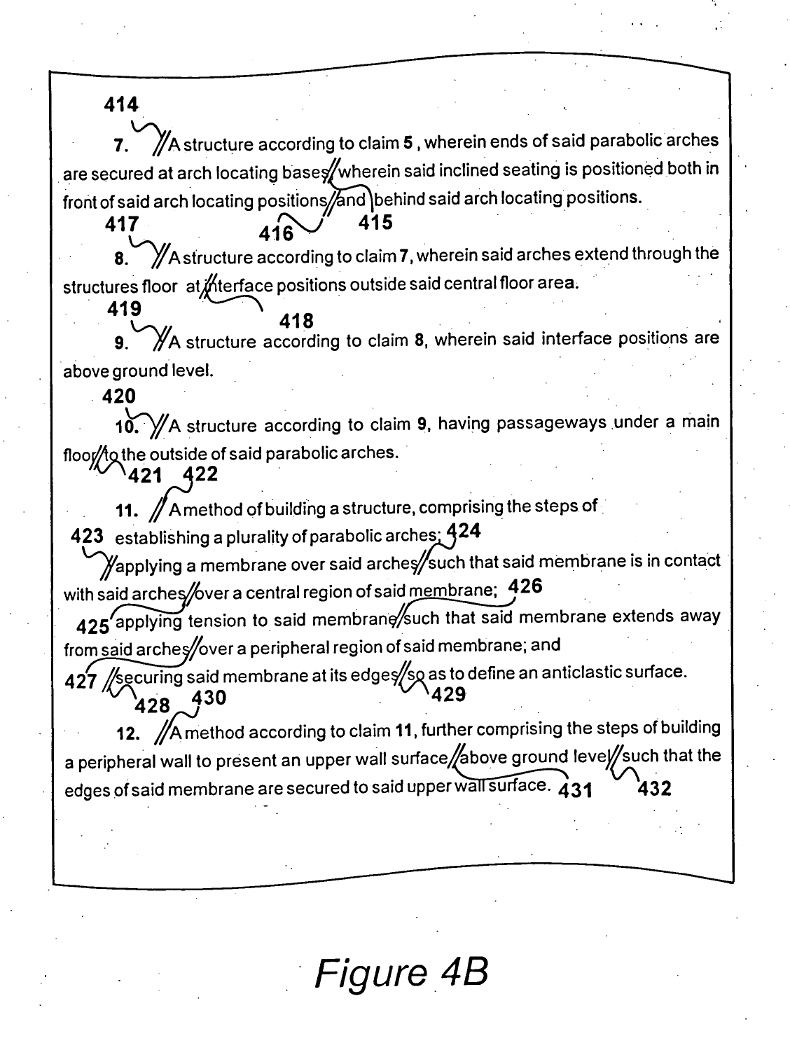

A written description of the apparatus shown in FIG. 3 is detailed in FIG. 4. In this example, the description includes a total of twelve sentence definitions, numbered one to twelve. The first sentence may be considered as being independent, whereas the second sentence is made dependent upon the first sentence. Similarly, the eleventh sentence is independent with the twelfth sentence being dependent thereon. Thus, independent sentence definitions exist with at least one further limiting dependent sentence definition. Each of the independent sentence definitions, one and eleven, and the dependent sentence definitions, two to ten and twelve, is constructed from one of more clauses defining an identifiable technical feature of the apparatus, method, system of device. Furthermore, clauses themselves may be broken down into individual elements, generally referring to separate aspects of what may be considered substantially the same technical feature.

In the example the sentence has been broken down into five elements, in which two line slashes identify the start of each of these elements. Thus, the first element starts at 401, a second element starts at 402, a third element starts at 403, a fourth element starts at 404 and the fifth element starts at 405.

A similar analysis may be performed upon the second (dependent) sentence thus, a first element starts at 406 and a second element starts at 407.

Sentence three is considered to be a single element 408. Similarly sentence four is considered to be a single element 409.

Sentence five is considered to consist of a first element 410 and a second element 411.

Sentence six is considered to consist of a first element 412 and a second element 413.

Sentence seven is considered to consist of a first element 414, a second element 415 and a third element 416.

Sentence eight is considered to consist of a first element 417 and a second element 418.

Sentence nine is considered to consist of a single element 419.

Sentence ten is considered to consist of a first element 420and a second element 421.

Sentence eleven is independent and is considered to consist of a first element 422, a second element 423, a third element 424, a fifth element 425, a sixth element 426, a seventh element 427, an eighth element 428 and a ninth element 429.

Finally, sentence twelve is considered to consist of a first element 430, a second element 431 and a third element 432.

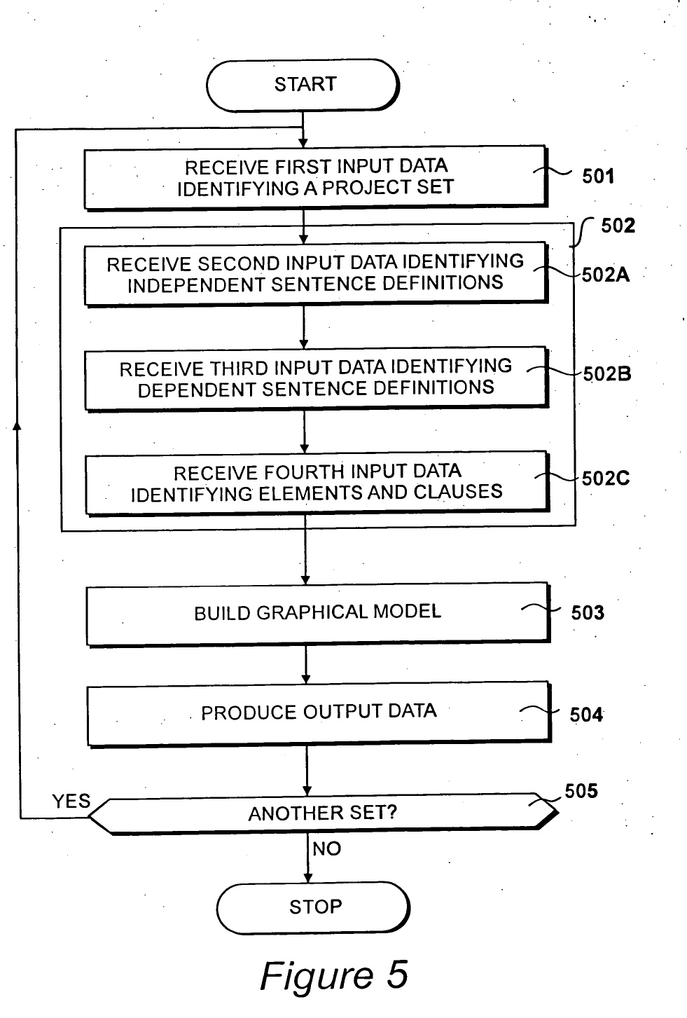

Having considered the sentence definitions as being constructed from elements, the definition data is now introduced to the data processing system 101. Procedures performed by the data processing system 101, in response to program instructions, is illustrated in FIG. 5.

After starting the procedure, first input data identifying a project set is received at step 501. This consists of defining data to the effect that a new project set is to be worked upon and, in a preferred embodiment, with result in the establishment of the stored identifiable data file.

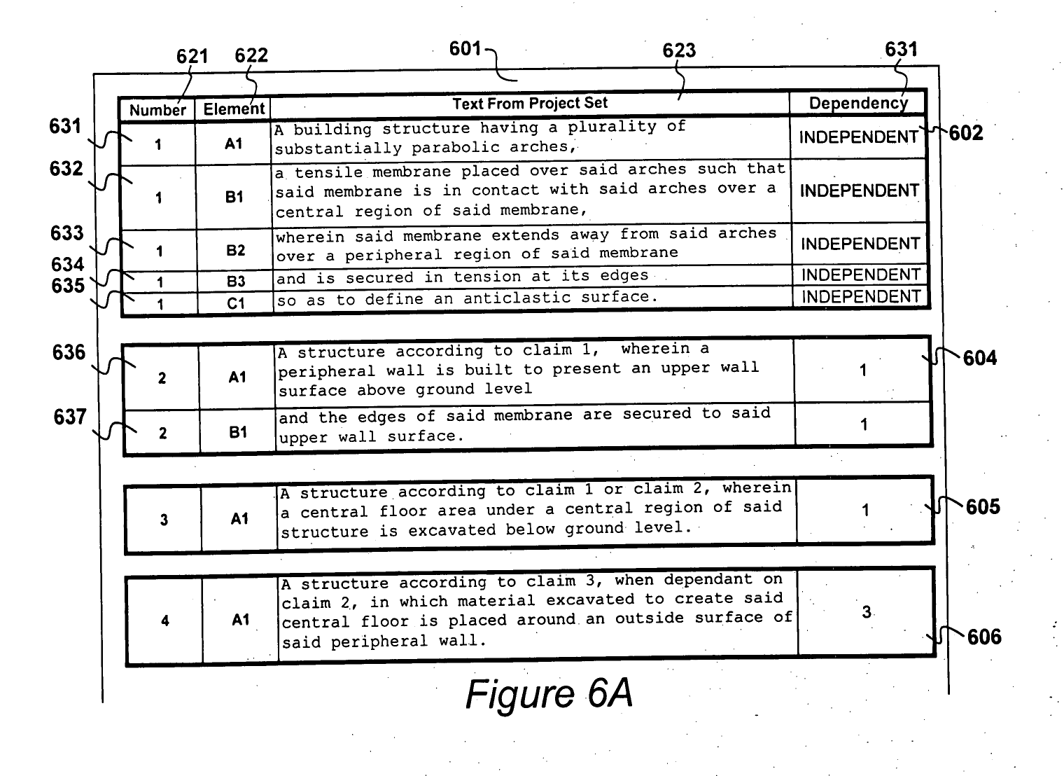

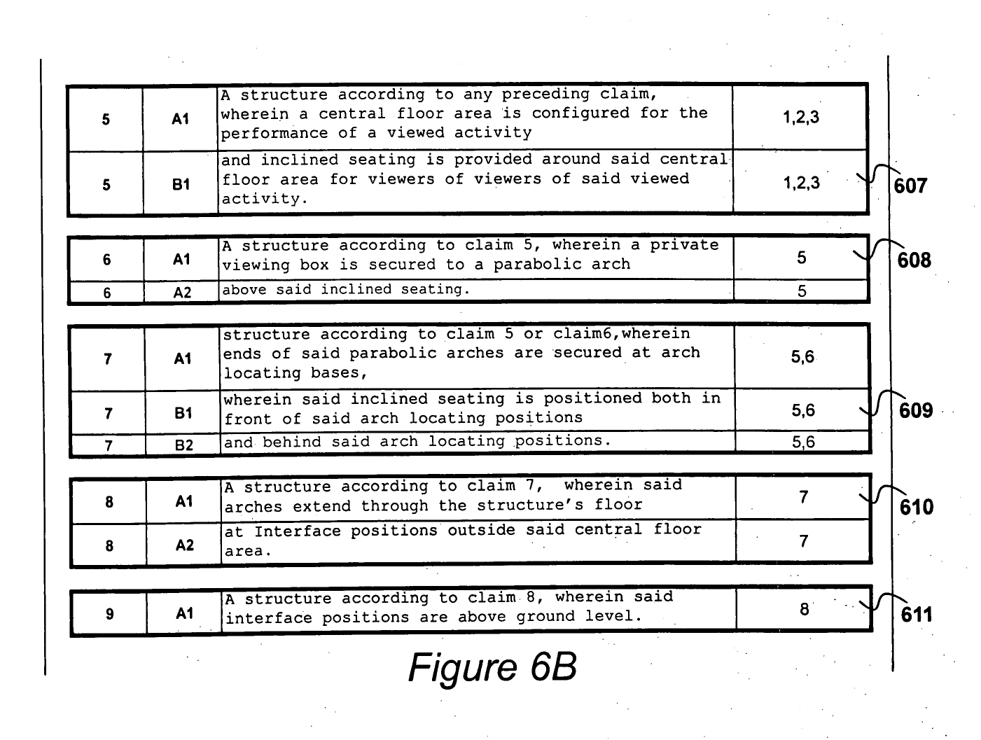

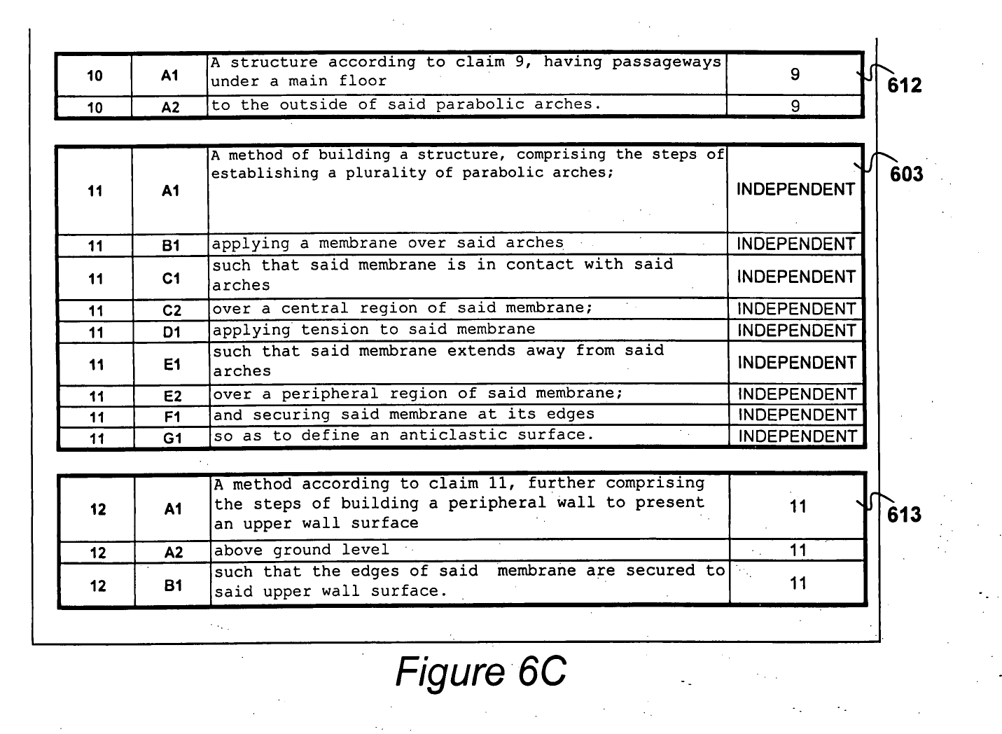

At step 502 specific input data is received such that, within said file, an appropriate data structure may be populated, as subsequently described with reference to FIG. 6.

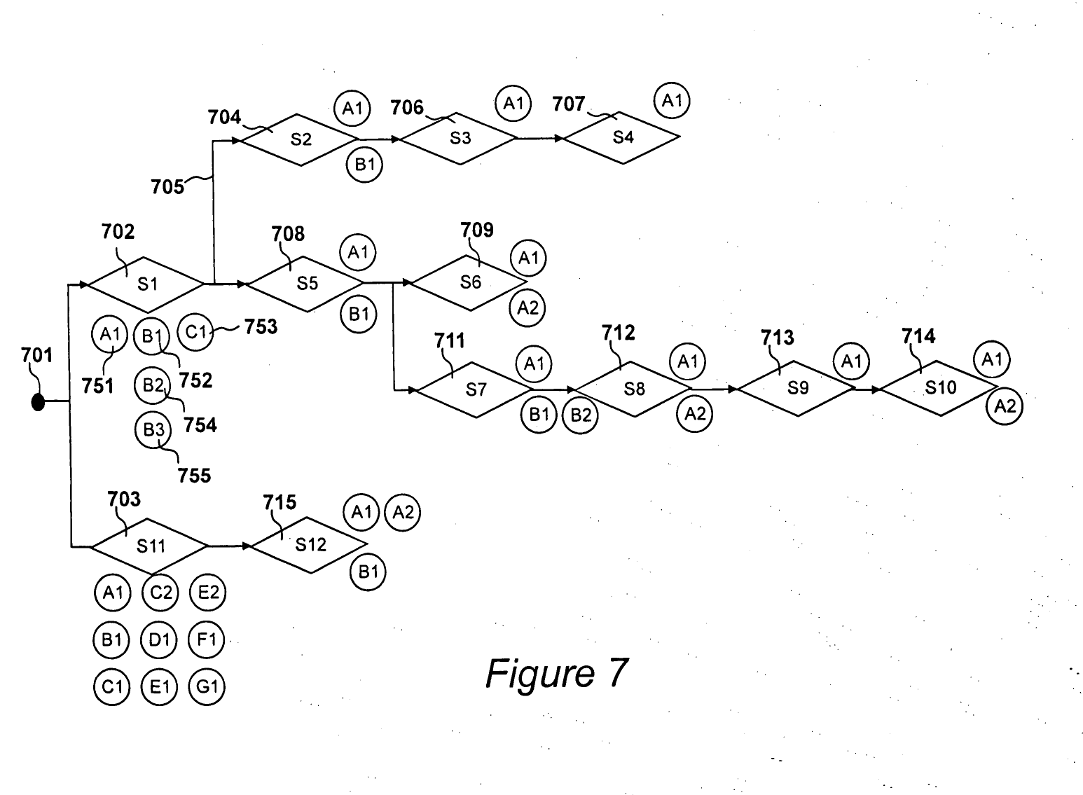

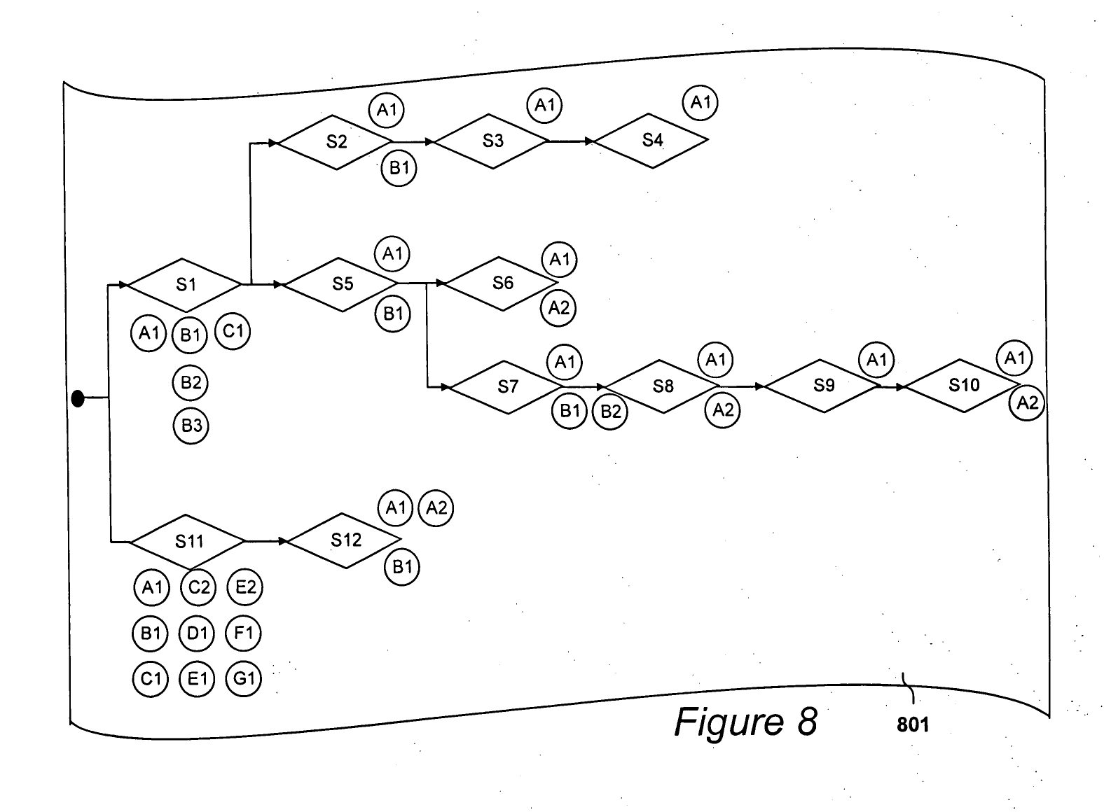

Thereafter, at step 503, a graphical model is built as illustrated in FIG. 7, whereafter output data may be produced, preferably in permanent form, as detailed in FIG. 8. At step 505 a question is asked as to whether another set of data is to be produced and when answered in the affirmative control is returned to step 501. Alternatively, when answered in the negative, the process terminates.

Step 502 is, in this embodiment, divided into three further steps identified as steps 502a, 502b and 502c.

At step 502a second input data is received identifying independent sentence definitions. In this example, data would be provided to the effect that a sentence exists, sentence 1 and a further sentence exists, namely sentence 11 and that these are independent.

At step 502b third input data is received identifying dependent sentence definitions, to the effect hat sentences two to ten and sentence twelve are dependent. At this point, no textural data has been entered and the reception of said first input data and said second input data relates to the structural relationship of the sentences within the project set.

At step 502c fourth input data is received identifying elements and the clauses. The fourth input data does include actual textural content and, in addition to the text of the elements being received, two variables are also populated, a first giving a clause reference and a second giving an element reference. Thus, two or more elements belonging to the same clause are given a similar clausal reference.

In a first embodiment, said fourth input data is received manually via said keyboard 102. However, in an alternative embodiment, the fourth input data representing the textural component may be received from a data file or may be received by a scanning operation. The relationship aspect of the fourth input data would be received in response to manual input.

The execution of step 505 results in the population of a data structure referred to as a project set deconstruction as illustrated in FIG. 6.

In response to receiving said first input data identifying a project set, the project's set deconstruction data file 601 is established.

In response to receiving the second input data, identifying independent sentence definitions, the data block 602 is established, for sentence one, and a second data block 603 is established for sentence eleven.

Similarly, in response to receiving the third input data, identifying dependent sentence definitions, data blocks 604 to 612 are established for dependent sentences two to ten, with data block 613 being established sentence twelve.

Each of the data blocks 602 to 613 include a first number field 621, an element field 622, a text field 623 and a dependency field 624. The number field identifies the particular sentence under consideration. Thus, for all entries in data block 602, the number field is set to one.

The element field identifies a unique reference for the particular element under consideration and consists essentially of two components. In this example, an element is identified by a letter followed by a numeral. Elements having a shared letter are considered to be technically related and as such fall within the same clause. Thus, in this example, a first entry at line 631 includes an element identification A1. Similarly, at line 632 an element entry B1 has been specified, with an entry B2 at line 633, B3 at line 634 and C1 at line 635. Thus, the analysis performed and described with reference to FIG. 4, has resulted in the element entries at lines 632, 633 and 634 being considered as forming part of a shared clause and as such are referenced B1, B2 and B3 respectively.

For each element identified in the process previously described with respect to FIG. 4, the relevant text is included within the text field 623. As previously described, this may received via manual input or, alternatively, it may be derived from existing machine-readable sources. Thus, in line 631, text field 623 has been populated by the text of element Al, consisting of “a building structure having a plurality of substantially parabolic arches,”. Sentence one is independent, in that it is not dependent upon an earlier sentence and as such the dependency field 624 is identified by the flag “independent” in all lines 631 to 635. This compares with data field 604, for example, in which the dependency flag has been set to one at lines 636 and 637 representing the fact that sentence two is dependent upon sentence one.

Having populated the data structure illustrated in FIG. 6, a graphical model is built, an example of which is illustrated in FIG. 7. A project set has a node 701. From this node, the process analyses the data structures of the project deconstruction as shown in FIG. 6. For each sentence definition within the set, a graphical object is established which, in this example, is illustrated as a diamond. Diamonds for independent sentence definitions are connected to the originating node. Thus, in the specific example a diamond 702 and a diamond 703 are each connected to the establishing node 701.

In this example, further graphical objects, again diamonds in the example, are established for each of the dependent nodes. Similarly, connecting lines between diamonds are established so as to represent the relationship in terms of dependency.

A diamond 604 is established representing the presence of sentence two and is connected via connection 705 to diamond 702 showing that sentence two is itself upon sentence one. Thus, diamonds 706 represent sentence three, dependent on two and diamond 707 represents sentence four, dependent on three (diamond 706).

A further line extends from diamond 702 resulting in a diamond 708 being established representing sentence five. From this extends a further diamond 709 representing the presence of sentence six.

Sentence seven is also dependent on sentence five, therefore a second connection 710 is made to diamond 711. From this extends diamond 712 for sentence eight which, having sentence nine being dependent thereon, results in the establishment of diamond 713. Sentence ten is dependent on sentence nine therefore this is represented by diamond 714, connected to diamond 713.

As previously stated, sentence eleven is independent and is represented by diamond 703. Sentence twelve is dependent upon sentence eleven and is represented by diamond 715 connected from diamond 703.

Each diamond, representing the existence of a sentence, has one or more circles, such as circle 751, located within its vicinity. Each of these circles represents a respective element, read from column 622 of the data structure of FIG. 6. Thus, sentence one has a total of five circles namely 752, 753, 754 and 755, in addition to previously referenced 751. Each of said circles 751 to 755 has a graphical indication located therein representing its element reference. Thus, circle 751 is referenced Al, 752 is reference B1, 753 is reference C1, 754 is reference B2 and 755 is reference B3.

Thus, the process continues for the remaining blocks of data 604 onwards etc resulting in circles being established at positions close to their respective sentence definitions.

After considering all of the data contained within the project set deconstruction data set as illustrated in FIG. 6, process 503 will have built a graphical model of the relationship between the elements and clauses showing how these elements and clauses combine to form each of the sentence definitions. In addition, the relationship between the sentence definitions themselves is illustrated, with the ordering of the graphical representations defining dependency and independent definitions being connected to a route starting point.

In use, it is possible to apply further graphical indications or modifications to these elements representing particular conditions as the data structure is being deployed. Thus, questions may be asked as to whether other technical installations have features that fall within the scope of particular elements, clauses or sentence definitions. In this way, it would be possible to determine the extent to which the data set as a whole is relevant to some third party activity.

Having built a graphical model, in response to the data stored in the project set deconstruction data set, it is possible to produce a visible output based on this graphical model. Having been used to facilitate the inputting of data, the visual display unit 104 may be used to display the resulting graphical representation of the data. Alternatively or in addition, a permanent record of the graphical display may be produced by printer 105 and printed onto a medium 801, as shown in FIG. 8.

1. A method of producing a graphical representation of a written description of an apparatus, method, system or device, wherein said description comprises:
one or more independent sentence definitions; and,
for at least one of said independent sentence definitions, at least one further limiting dependent sentence definition; wherein
each of said independent sentence definitions and said dependent sentence definitions is constructed from one or more clauses describing an identifiable technical feature of said apparatus, method, system or device, the method comprising the steps of, at a data processing system:
(a) receiving first input data identifying a project set of sentence definitions;
(b) receiving second input data identifying independent sentence definitions;
(c) receiving third input data identifying dependent sentence definitions along with an indication of the sentence definition or definitions upon which said dependent sentence definitions are dependent;
(d) receiving fourth input data identifying clauses along with an indication of the sentence definitions of which they form a part thereof;
(e) building a graphical model of the relationship between said clauses showing how said clauses combine to form said sentence definitions; and
(f) producing output data showing an eye-readable graphical representation of said graphical model.

2. A method according to claim 1, wherein the reception of said first input data identifying a project set of sentence definitions results in the establishment of a data structure with an individual structure being defined for each of said sentence definitions.

3. A method according to claim 1, wherein the reception of said third input data results in the establishment of graphical indications graphically connected to previously defined graphical indications representing a dependency.

4. A method according to claim 1, wherein textural data defining said clauses is received from a machine-readable source.

5. A method according to claim 1, wherein said clauses may be represented by an element or a plurality of elements and each of said elements includes a designating pair showing their mutual relationship.

6. A method according to claim 1, wherein the relationship between said clauses is shown by clustering graphical representations of clauses around their respective representation for a sentence definition.

7. A method according to claim 1, wherein output data is produced in eye-readable form upon a permanent data carrying medium.

8. A method according to claim 1, wherein the existence of sentence definitions is represented by the inclusion of a graphical indication of a particular shape.

9. A data processing system, configured to:
receive first input data in the form of a written description identifying a project set of sentence definitions representing an apparatus, method, system or device, the written description comprising one or more independent sentence definitions; and, for at least one of said independent sentence definitions, at least one further limiting dependent sentence definition;
receive second input data identifying independent sentence definitions;
receive third input data identifying dependent sentence definitions along with an indication of the sentence definition or definitions upon which said dependent sentence definitions are dependent;
receive fourth input data identifying clauses along with an indication of the sentence definitions of which they form a part thereof;
build a graphical model of the relationship between said clauses showing how said clauses combine to form said sentence definitions; and
produce output data showing an eye-readable graphical representation of said graphical model, whereby a graphical representation is produced of said written description.

10. Apparatus according to claim 9, wherein the reception of said first input data identifying a project set of sentence definitions results in the establishment of a data structure with an individual structure being defined for each of said sentence definitions.

11. Apparatus according to claim 9, wherein the reception of said third input data results in the establishment of graphical indications graphically connected to previously defined graphical indications representing a dependency.

12. A method according to claim 9, wherein textural data defining said clauses is received from a machine-readable source.

13. Apparatus according to claim 9, wherein said clauses may be represented by an element or a plurality of elements and each of said elements includes a designating pair showing their mutual relationship.

14. A method according to claim 9, wherein the relationship between said clauses is shown by clustering graphical representations of clauses around their respective representation for a sentence definition.

15. A method according to claim 9, wherein output data is produced in eye-readable form upon a permanent data carrying medium.

16. A method according to claim 9, wherein the existence of sentence definitions is represented by the inclusion of a graphical indication of a particular shape.
